(19) United States
(12) Patent Application Publication
(10) Pub. No.: US 2023/0178840 A1
(43) Pub. Date: Jun. 8, 2023

(54) BATTERY WIRING MODULE

(71) Applicant: SUMITOMO WIRING SYSTEMS, LTD., Mie (JP)

(72) Inventors: Hiroshi SATO, Mie (JP); Ryota MORI, Mie (JP); Hisayoshi YAITA, Mie (JP); Masami SUZUKI, Mie (JP); Maya NAKASUKA, Mie (JP)

(21) Appl. No.: 17/924,084

(22) PCT Filed: May 18, 2021
(86) PCT No.: PCT/JP2021/018756

§ 371 Date: Nov. 8, 2022

(30) Foreign Application Priority Data
May 25, 2020 (JP) 2020-090490

(51) Int. Cl. H01M 50/298; H01M 50/507

(52) U.S. Cl. CPC H01M 50/298; H01M 50/507

(57) ABSTRACT

One problem to be solved by the present disclosure is to provide a battery wiring module that can facilitate parts control. A case (12) includes a first case body (21) including first wire inserting portions (31), a second case body (22) including second wire inserting portions (41), first covers (24) attached to the first case body (21) to cover the first wire inserting portions (31), and second covers (25) attached to the second case body (22) to cover the second wire inserting portions (41). Furthermore, the first covers (24) and the second covers (25) have shapes identical to each other.

### TECHNICAL FIELD

The present disclosure relates to a battery wiring module.

### BACKGROUND

For example, as disclosed in Patent Document 1, in a vehicle such as an electric vehicle or a hybrid vehicle, a battery wiring module is mounted to a high-voltage secondary battery installed as a power source for driving the vehicle. The battery wiring module of Patent Document 1 includes electric wires electrically connected to the secondary battery and a case that contains the electric wires. The case of the battery wiring module has a plurality of case bodies aligned in the longitudinal direction of the electric wires and a plurality of covers corresponding to the plurality of case bodies. Each case body includes a wire inserting portion having a groove shape through which an electric wire is inserted, and each cover covers the wire inserting portion of a corresponding case body. The covers protect the electric wires passing through the wire inserting portions of the case bodies. According to this configuration, for example, when the secondary battery expands due to heat in the longitudinal direction of the electric wires, the case bodies and the covers move in the longitudinal direction of the electric wire in response to the heat expansion of the secondary battery, providing highly reliable connection between the secondary battery and the battery wiring module.

### PRIOR ART DOCUMENT

### Patent Document

Patent Document 1: JP 2013-161566 A

### SUMMARY OF THE INVENTION

### Problems to be Solved

In the battery wiring module of Patent Document 1, each cover is integrated with a case body via a hinge. However, there are cases where the cover is not integrated with a case body due to design constraints, etc. In that case, as each cover is a separate component from the case body, parts control becomes complicated if the covers have different shapes. In recent vehicles, the secondary battery tends to be larger, and as the number of case bodies increases along with the size of the secondary battery, the number of covers also increases in configurations in which the covers are not integrated with the case bodies, thus making parts control particularly complicated.

Accordingly, one object is to provide a battery wiring module that facilitates parts control.

### Means to Solve the Problem

A battery wiring module of the present disclosure is one that is assembled to a secondary battery, including electric wires electrically connected to the secondary battery, and a case containing the electric wires, wherein the case includes a first case body including a first wire inserting portion through which the electric wires are inserted, a second case body including a second wire inserting portion through which the electric wires are inserted, a first cover assembled to the first case body for covering the first wire inserting portion, and a second cover assembled to the second case body for covering the second wire inserting portion, wherein the first cover and the second cover have shapes identical to each other.

### Effect of the Invention

According to the present disclosure, it is possible to provide a battery wiring module that facilitates parts control.

### BRIEF DESCRIPTION OF THE DRAWINGS

FIG. 1 is a perspective view of a battery wiring module of an embodiment.

FIG. 2 is a plan view of the battery wiring module of the embodiment, showing a state in which first, second, and third covers have been removed.

FIG. 3 is an enlarged perspective view of a part of the battery wiring module of the embodiment.

FIG. 4 is an enlarged perspective view of a part of the battery wiring module of the embodiment.

FIG. 5 is a plan view of the battery wiring module of the embodiment, illustrating how the first, second, and third covers are attached.

### DETAILED DESCRIPTION TO EXECUTE THE INVENTION

### Description of Embodiments

First, embodiments of the present disclosure will be listed and described.

A battery wiring module of the present disclosure is:

[1] A battery wiring module for attachment to a secondary battery, including: electric wires configured to be electrically connected to the secondary battery; and a case configured to house the electric wires, wherein the case includes a first case body including a first wire inserting portion through which the electric wires are inserted, a second case body including a second wire inserting portion through which the electric wires are inserted, a first cover configured to be attached to the first case body and cover the first wire inserting portion, and a second cover configured to be attached to the second case body and cover the second wire inserting portion, and the first cover and the second cover have shapes identical to each other.

According to this configuration, the first cover and the second cover have shapes identical to each other, and thus the first cover and the second cover are not treated as separate parts in parts control, which results in the facilitation of parts control.

[2] An aspect is possible in which the first wire inserting portion includes a first bottom wall portion, a pair of first side wall portions extending from the first bottom wall portion, and a plurality of first engaged portions provided on the first side wall portions along a direction in which the electric wires are inserted, the second wire inserting portion includes a second bottom wall portion, a pair of second side wall portions extending from the second bottom wall portion, and a plurality of second engaged portions provided on the second side wall portions along a direction in which the electric wires are inserted, the first cover includes a plurality of first engaging portions configured to engage with the plurality of first engaged portions, the second cover includes a plurality of second engaging portions configured to engage with the plurality of second engaged portions, and arrangement intervals of the plurality of first engaged portions are set identical to arrangement intervals of the plurality of second engaged portions.

According to this configuration, the arrangement intervals of the plurality of first engaged portions are the same as the arrangement intervals of the plurality of second engaged portions, and thus even if the first cover and the second cover have an identical shape, they can suitably engage with the first wire inserting portions and the second wire inserting portions, respectively.

[3] An aspect is possible in which the first wire inserting portion includes a first bottom wall portion and a pair of first side wall portions extending from the first bottom wall portion, the second wire inserting portion includes a second bottom wall portion and a pair of second side wall portions extending from the second bottom wall portion, and a distance between the pair of first side wall portions is set identical to a distance between the pair of second side wall portions.

According to this configuration, the distance between the pair of first side wall portions is the same as the distance between the pair of second side wall portions, and thus the first wire inserting portion and the second wire inserting portion can be suitably covered by the first cover and the second cover, respectively, even if the first cover and the second cover have an identical shape.

[4] An aspect is possible in which the first case body includes a plurality of the first wire inserting portions, a plurality of the first covers are provided in correspondence with the plurality of first wire inserting portions, the second case body includes a plurality of the second wire inserting portions, a plurality of the second covers are provided in correspondence with the plurality of second wire inserting portions, and the first covers and the second covers all have an identical shape.

According to this configuration, the first covers and the second covers all have an identical shape, and thus parts control can be facilitated even in a case that includes a large number of first covers and second covers.

[5] An aspect is possible in which the first cover and the second cover each have a mark thereon that indicates an orientation of attachment to a corresponding first case body or second case body.

According to this configuration, even if the first cover and the second cover have an identical shape, the marks on the first cover and the second cover allow for the attachment of the first cover and the second cover, which have shapes identical to each other, while avoiding the wrong orientation of attachment. As a result, the first cover and the second cover can be smoothly attached.

[6] An aspect is possible in which the marks are provided on a surface of the first cover and a surface of the second cover.

According to this configuration, a mark is provided on each of a surface of the first cover and a surface of the second cover, and thus during the attachment of the first cover and the second cover, verification can be easily made by visual observation of the marks.

[7] An aspect is possible in which the case includes a third case body having a plurality of third wire inserting portions through which the electric wires are inserted, and a plurality of third covers configured to be attached to the third case body and cover the plurality of third wire inserting portions, and the plurality of third covers have shapes identical to each other.

According to this configuration, the plurality of third covers have shapes identical to each other, and thus parts control can be facilitated even in a configuration with an increased total number of covers due to the provision of the third covers in addition to the first covers and second covers.

### DETAILS OF EMBODIMENTS OF THE PRESENT DISCLOSURE

Specific examples of a battery wiring module of the present disclosure will be described below with reference to the drawings. In each drawing, for convenience of description, portions of the configuration may be exaggerated or simplified. Also, the dimensional proportion of each portion may differ in each drawing. Note that the present invention is not limited to these examples, and is indicated by the claims, and is intended to include all modifications within the meaning and range of equivalency to the claims.

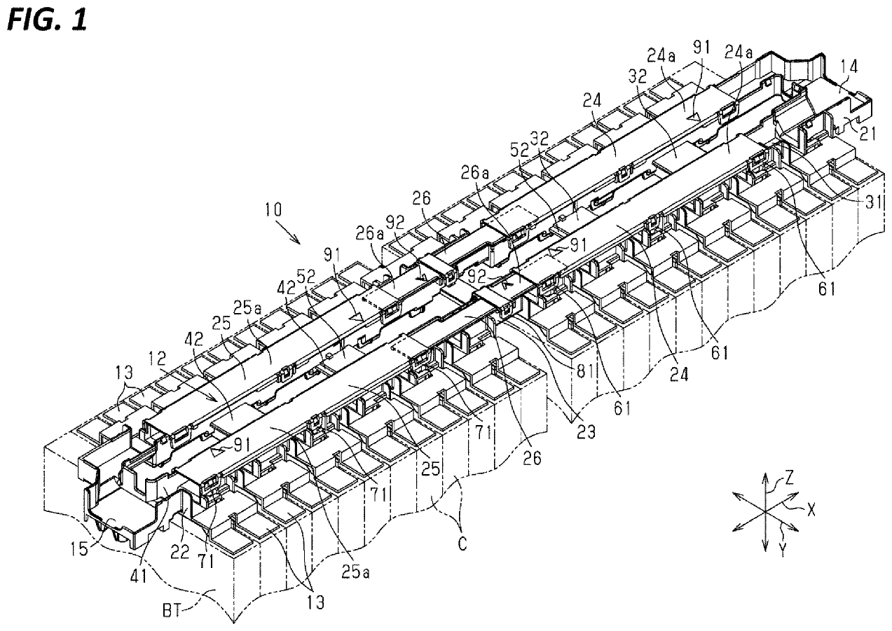

As shown in FIG. 1, a battery wiring module 10 of the present embodiment is for attachment to a secondary battery BT installed in, for example, an electric vehicle or a hybrid vehicle. The secondary battery BT provides electric power to a drive motor for an unshown vehicle. The secondary battery BT receives power supply from the drive motor and a power generation motor, depending on the state of charge and the operating condition of the vehicle.

The secondary battery BT includes a plurality of battery cells C. The secondary battery BT is formed in the shape of an approximate rectangular solid by arranging the plurality of battery cells C in one direction, for example. The battery wiring module 10 is mounted on one side of the secondary battery BT. Note that, in the following description, the surface of the secondary battery BT on which the battery wiring module 10 is mounted is referred to as the top surface, and the side of the secondary battery BT on which the battery wiring module 10 is located is referred to as the upward side. The X-axis among the mutually orthogonal XYZ axes in the drawings represents a longitudinal direction X of a case 12 of the battery wiring module 10, the Y-axis represents a width direction Y of the case 12, and the Z-axis represents a height direction Z of the case 12. The battery cells C are aligned side-by-side along the longitudinal direction X of the case 12.

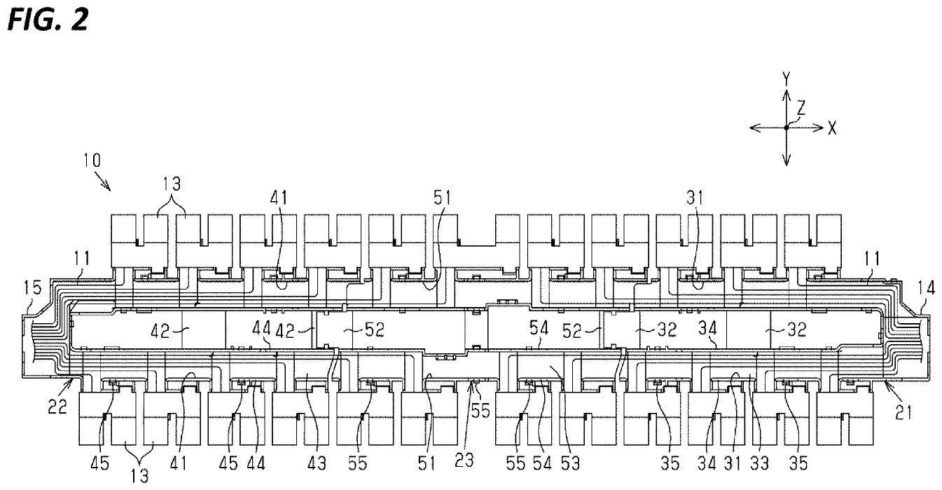

As shown in FIGS. 1 and 2, the battery wiring module 10 includes a plurality of electric wires 11 electrically connected to the secondary battery BT and a case 12 that houses the electric wires 11. Note that the electric wires 11 are omitted from the view in FIG. 1.

Furthermore, the battery wiring module 10 includes, for example, a plurality of busbars 13 supported by the case 12. The busbars 13 are arranged side-by-side along the longitudinal direction X of the case 12 on the two sides of the case 12 in the width direction Y. Unshown positive and negative terminals provided on the top surface of each battery cell C are connected to a busbar 13.

As shown in FIG. 2, each busbar 13 is electrically connected to a corresponding electric wire 11. Each electric wire 11 is inserted through the interior of the case 12 in the longitudinal direction X thereof. Some of the electric wires 11 are drawn out of the case 12 through a first wire draw-out portion 14 formed at one end in the longitudinal direction X of the case 12, and the remaining electric wires 11 are drawn out of the case 12 through a second wire draw-out portion 15 formed at the other end in the longitudinal direction X of the case 12.

Case 12

As shown in FIG. 1, the case 12 includes a first case body 21, a second case body 22, and a third case body 23 arranged side-by-side in the longitudinal direction X of the case 12, as well as first covers 24, second covers 25, and third covers 26 corresponding to the first case body 21, the second case body 22, and the third case body 23, respectively. The third case body 23 is disposed between the first case body 21 and the second case body 22 in the longitudinal direction X of the case 12. Moreover, the third covers 26 are disposed between the first covers 24 and the second covers 25 in the longitudinal direction X of the case 12. Note that the first case body 21 includes the above-described first wire draw-out portion 14, and the third case body 23 includes the above-described second wire draw-out portion 15.

The first case body 21 and the first covers 24 are separate members. The second case body 22 and the second covers 25 are separate members. The third case body 23 and the third covers 26 are separate members. Additionally, the first case body 21, the second case body 22, and the third case body 23 are separate members. Additionally, the first covers 24, the second covers 25, and the third covers 26 are separate members. Note that the first case body 21, the second case body 22, the third case body 23, the first covers 24, the second covers 25, and the third covers 26 are made of a synthetic resin, for example.

First Case Body 21

As shown in FIG. 2, the first case body 21 includes first wire inserting portions 31 having a groove shape through which the electric wires 11 are passed. Note that FIG. 2 is a plan view of the battery wiring module 10 in a state where the first covers 24, the second covers 25, and the third covers 26 have been removed.

The first wire inserting portions 31 extend in the longitudinal direction X of the case 12. In addition, the first case body 21 of the present embodiment includes two first wire inserting portions 31 arranged side-by-side in the width direction Y of the case 12, for example. The two first wire inserting portions 31 are coupled to each other via first coupling portions 32.

Each of the first wire inserting portions 31 includes a first bottom wall portion 33, a pair of first side wall portions 34 extending upward from the first bottom wall portion 33, and a plurality of first engaged portions 35 provided on each of the first side wall portions 34. The pair of first side wall portions 34 oppose each other in the width direction Y. The first wire inserting portions 31 are formed in the shape of a groove that is open upward due to the first bottom wall portion 33 and the first side wall portions 34. Electric wires 11 are inserted between the first side wall portions 34.

The plurality of first engaged portions 35 protrude from the outer surfaces of the first side wall portions 34. In addition, the first engaged portions 35 on one of the first side wall portions 34 are provided at the same positions as the first engaged portions 35 on the other first side wall portion 34 in the longitudinal direction X of the case 12.

Second Case Body 22

The second case body 22 includes second wire inserting portions 41 having a groove shape through which the electric wires 11 are passed. The second wire inserting portions 41 extend in the longitudinal direction X of the case 12. In addition, the first case body 21 of the present embodiment includes two second wire inserting portions 41 arranged side-by-side in the width direction Y of the case 12, for example. The two second wire inserting portions 41 are coupled to each other via second coupling portions 42.

Each of the second wire inserting portions 41 includes a second bottom wall portion 43, a pair of second side wall portions 44 extending upward from the second bottom wall portion 43, and second engaged portions 45 provided on each of the second side wall portions 44. The pair of second side wall portions 44 oppose each other in the width direction Y. The second wire inserting portions 41 are formed in the shape of a groove that is open upward due to the second bottom wall portion 43 and the second side wall portions 44. Electric wires 11 are inserted between the second side wall portions 44.

The plurality of second engaged portions 45 protrude from the outer surfaces of the second side wall portions 44. In addition, the second engaged portions 45 on one of the second side wall portions 44 are provided at the same positions as the second engaged portions 45 on the other second side wall portion 44 in the longitudinal direction X of the case 12.

Third Case Body 23

The third case body 23 includes third wire inserting portions 51 having a groove shape through which the electric wires 11 are passed. The third wire inserting portions 51 extend in the longitudinal direction X of the case 12. In addition, the third case body 23 of the present embodiment includes two third wire inserting portions 51 arranged side-by-side in the width direction Y of the case 12, for example. The two third wire inserting portions 51 are coupled to each other via third coupling portions 52. Furthermore, the above-described first wire inserting portions 31, second wire inserting portions 41, and third wire inserting portions 51 are arranged side-by-side along the longitudinal direction X of the case 12.

Each of the third wire inserting portions 51 includes a third bottom wall portion 53, a pair of third side wall portions 54 extending upward from the third bottom wall portion 53, and a plurality of third engaged portions 55 provided on each of the third side wall portions 54. The pair of third side wall portions 54 oppose each other in the width direction Y. The third wire inserting portions 51 are formed in the shape of a groove that is open upward due to the third bottom wall portion 53 and the third side wall portions 54. In addition, the third wire inserting portions 51 are open upward. Electric wires 11 are inserted between the third side wall portions 54.

The plurality of third engaged portions 55 protrude from the outer surfaces of the third side wall portions 54. In addition, the third engaged portions 55 on one of the third side wall portions 54 are provided at the same positions as the third engaged portions 55 on the other third side wall portion 54 in the longitudinal direction X of the case 12.

First Covers 24

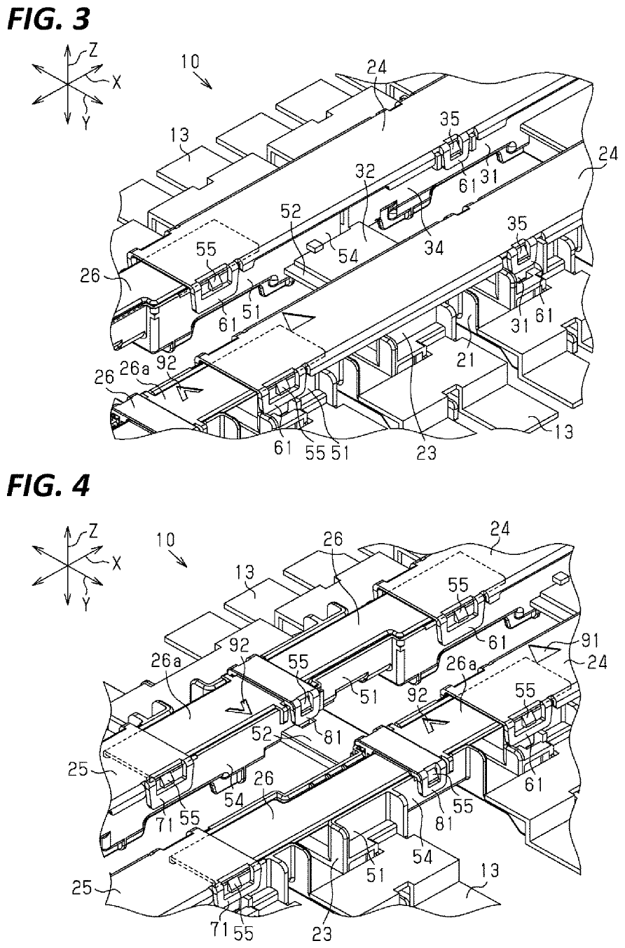

As shown in FIGS. 1 and 3, the two first covers 24 are provided in correspondence with the two first wire inserting portions 31 of the first case body 21 in the present embodiment. The first covers 24 are attached to the first case body 21 in such a manner as to cover the first wire inserting portions 31 from above. The first covers 24 include first engaging portions 61 for engaging with the first engaged portions 35 of the first wire inserting portions 31. The plurality of first engaging portions 61 are provided in one-to-one correspondence with the plurality of first engaged portions 35 of the first wire inserting portions 31. The first engaging portions 61 engage with the first engaged portions 35 in the direction of approaching the openings of the first wire inserting portions 31, i.e., in the height direction Z. The first covers 24 are attached to the first wire inserting portions 31 in this way. Note that the first engaging portions 61 are provided on both sides in the width direction Y of the first covers 24.

Second Covers 25

As shown in FIGS. 1 and 2, the two second covers 25 are provided in correspondence with the two second wire inserting portions 41 of the second case body 22 in the present embodiment. The second covers 25 are attached to the second case body 22 in such a manner as to cover the second wire inserting portions 41 from above. The second covers 25 include second engaging portions 71 for engaging with the second engaged portions 45 of the second wire inserting portions 41. A plurality of second engaging portions 71 are provided in one-to-one correspondence with the plurality of second engaged portions 45 of the second wire inserting portions 41. The second engaging portions 71 engage with the second engaged portions 45 in the direction of approaching the openings of the second wire inserting portions 41, i.e., in the height direction Z. The second covers 25 are attached to the second wire inserting portions 41 in this way. Note that the second engaging portions 71 are provided on both sides in the width direction Y of the second covers 25.

Third Covers 26

As shown in FIGS. 1 and 4, the two third covers 26 are provided in correspondence with the two third wire inserting portions 51 of the third case body 23 in the present embodiment. The two third covers 26 have shapes identical to each other. The third covers 26 are attached to the third case body 23 in such a manner as to cover the third wire inserting portions 51 from above. The third covers 26 include third engaging portions 81 for engaging with the third engaged portions 55 of the third wire inserting portions 51. The third engaging portions 81 engage with the third engaged portions 55 in the direction of approaching the openings of the third wire inserting portions 51, i.e., in the height direction Z. The third covers 26 are attached to the third wire inserting portions 51 in this way. Note that the third engaging portions 81 are provided on both sides in the width direction Y of the third covers 26.

The first covers 24 extend toward the third case body 23 in the longitudinal direction X of the case 12 with ends in the longitudinal direction X of the first covers 24 positioned above the third wire inserting portions 51. The first engaging portions 61 provided on those ends in the longitudinal direction X of the first covers 24 engage with some of the plurality of third engaged portions 55. The ends of the third covers 26 on the side corresponding to the first covers 24 are positioned below the first covers 24.

The second covers 25 extend toward the third case body 23 in the longitudinal direction X of the case 12 with ends in the longitudinal direction X of the second covers 25 positioned above the third wire inserting portions 51. The second engaging portions 71 provided on those ends in the longitudinal direction X of the second covers 25 engage with some of the plurality of third engaged portions 55. The ends of the third covers 26 on the side corresponding to the second covers 25 are positioned below the second covers 25.

As described above, the case 12 of the present embodiment has six covers in total covering portions through which the electric wires 11 are inserted. Among the six covers, the two first covers 24 and the two second covers 25 have an identical shape. That is, the first covers 24 and the second covers 25 are identical parts. Therefore, the arrangement intervals of the plurality of first engaging portions 61 of the first cover 24 are the same as the arrangement intervals of the plurality of second engaging portions 71 of the second cover 25 in the longitudinal direction X of the case 12.

Moreover, as shown in FIG. 2, the arrangement intervals of the plurality of first engaged portions 35 of the first wire inserting portions 31 are the same as the arrangement intervals of the plurality of second engaged portions 45 of the second wire inserting portions 41 in the longitudinal direction X of the case 12. Moreover, the distance between the pair of first side wall portions 34 of each first wire inserting portion 31 in the width direction Y is the same as the distance between the pair of second side wall portions 44 of each second wire inserting portion 41 in the width direction Y.

As shown in FIG. 1, for example, a mark 91 is provided on each of the first covers 24 and each of the second covers 25. A mark 91 is provided on a surface 24a of each of the first covers 24 and on a surface 25a of each of the second covers 25. The surface 24a of the first cover 24 is, for example, the top surface of the first cover 24. Furthermore, the surface 25a of the second cover 25 is, for example, the top surface of the second cover 25. The marks 91 indicate the orientation in which the first covers 24 and the second covers 25 are to be attached as seen in plan view or in the height direction Z. The marks 91 are made visible by being formed as projections or depressions on the surfaces 24a of the first covers 24 and on the surfaces 25a of the second covers 25. In addition, the marks 91 have a shape with directionality, such as a triangular shape as seen in plan view in the present embodiment.

Marks 92 are provided on the surfaces 26a of the third covers 26. The surfaces 26a of the third covers 26 are, for example, the top surfaces of the third covers 26. The marks 92 indicate the orientation in which the third covers 26 are to be attached as seen in plan view or in the height direction Z. The marks 92 are made visible by being formed as projections or depressions on the surfaces 26a of the third covers 26. The marks 92 on the third covers 26 have, for example, a different shape from the marks 91 of the first covers 24 and the second covers 25. In addition, the marks 91 have a shape with directionality.

Operations of the present embodiment will now be described.

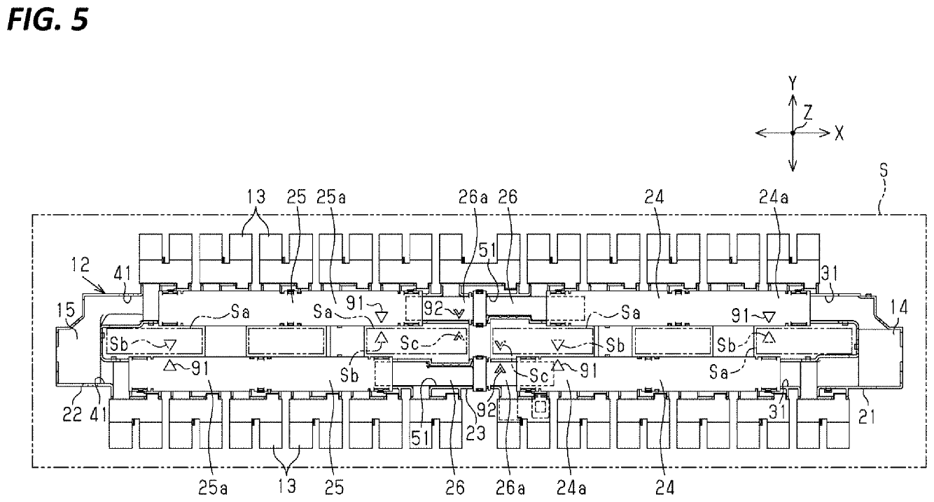

As shown in FIG. 5, during the operation to attach the electric wires 11 to the case 12, the first case body 21, the second case body 22, and the third case body 23 are placed on a workbench S. At this time, inserting portions Sa that protrude from the top surface of the workbench S are inserted between the pair of first wire inserting portions 31, between the pair of second wire inserting portions 41, and between the pair of third wire inserting portions 51. Note that the electric wires 11 are omitted from the view in FIG. 5.

The first, second, and third covers 24 to 26 are attached after the electric wires 11 are placed in the first, second, and third case bodies 21 to 23.

At this point, to attach the first covers 24 and the second covers 25, the first covers 24 and the second covers 25 are attached based on a plurality of counterpart marks Sb provided at predetermined positions on the top surfaces of the inserting portions S a. The counterpart marks Sb have a shape that corresponds to the marks 91 of the first covers 24 and the second covers 25. For example, the counterpart marks Sb have a shape and size identical to that of the marks 91 as seen in plan view. To attach the first covers 24, the marks 91 on the first covers 24 are oppositely aligned with the counterpart marks Sb. To attach the second covers 25, the marks 91 on the second covers 25 are oppositely aligned with the counterpart marks Sb. As a result, it is possible to attach the first and second covers 24 and 25 having shapes identical to each other while avoiding the wrong orientation of attachment.

Furthermore, to attach the third covers 26, the third covers 26 are attached based on a plurality of counterpart marks Sc provided at predetermined positions on the top surfaces of the inserting portions Sa. The counterpart marks Sc have a shape that corresponds to the marks 92 of the third covers 26. For example, the counterpart marks Sc have a shape and size identical to that of the marks 92 as seen in plan view. To attach the third covers 26, the marks 92 are oppositely aligned with the counterpart marks Sc. As a result, it is possible to attach the third covers 26 having shapes identical to each other while avoiding the wrong orientation of attachment.

Effects of the present embodiment will now be described.

(1) Due to the first cover 24 and the second cover 25 having shapes identical to each other, the first covers 24 and the second covers 25 are not treated as separate parts in parts control, which results in the facilitation of parts control. Moreover, in the present embodiment, due to the third covers 26 having shapes identical to each other, there are only two types of cover parts despite the fact that six covers for the electric wires 11 are provided in the case 12.

(2) The first wire inserting portions 31 include a first bottom wall portion 33, a pair of first side wall portions 34 extending from the first bottom wall portion 33, and a plurality of first engaged portions 35 provided on the first side wall portions 34 along the direction in which the electric wires 11 are inserted. The second wire inserting portions 41 include a second bottom wall portion 43, a pair of second side wall portions 44 extending from the second bottom wall portion 43, and a plurality of second engaged portions 45 provided on the second side wall portions 44 along the direction in which the electric wires 11 are inserted. The first covers 24 include a plurality of first engaging portions 61 that engage with the plurality of first engaged portions 35, and the second covers 25 include a plurality of second engaging portions 71 that engage with the plurality of second engaged portions 45. Furthermore, the arrangement intervals of the plurality of first engaged portions 35 are set identical to the arrangement intervals of the plurality of second engaged portions 45. According to this configuration, the arrangement intervals of the plurality of first engaged portions 35 are the same as the arrangement intervals of the plurality of second engaged portions 45, and thus even if the first covers 24 and the second covers 25 have an identical shape, they can suitably engage with the first wire inserting portions 31 and the second wire inserting portions 41, respectively.

(3) Moreover, the distance between the pair of first side wall portions 34 of each first wire inserting portion 31 is set identical to the distance between the pair of second side wall portions 44 of each second wire inserting portion 41. According to this configuration, the first wire inserting portions 31 and the second wire inserting portions 41 can be suitably covered by the first covers 24 and the second covers 25, respectively, even if the first covers 24 and the second covers 25 have an identical shape.

(4) The first case body 21 includes the plurality of first inserting portions 31, and the plurality of first covers 24 are provided in correspondence with the plurality of first wire inserting portions 31. Moreover, the second case body 22 includes the plurality of second inserting portions 41, and the plurality of second covers 25 are provided in correspondence with the plurality of second wire inserting portions 41. According to this configuration, the first covers 24 and the second covers 25 all have an identical shape, and thus parts control can be made easy even with a case 12 that includes a large number of first covers 24 and second covers 25.

(5) Each of the first covers 24 and the second covers 25 has a mark 91 thereon that indicates the orientation of attachment to the corresponding first case body 21 or second case body 22. According to this configuration, even if the first covers 24 and the second covers 25 have an identical shape, the mark 91 provided on each of the first covers 24 and the second covers 25 enables the attachment of the first covers 24 and the second covers 25 while avoiding the wrong orientation of attachment. As a result, the first covers 24 and the second covers 25 can be smoothly attached.

(6) The marks 91 are provided on the surfaces 24a of the first covers 24 and on the surfaces 25a of the second covers 25. According to the configuration, the marks 91 are provided on the surfaces 24a of the first covers 24 and on the surfaces 25a of the second covers 25, and thus verification can be easily made by visual observation of the marks 91 during the attachment of the first covers 24 and the second covers 25.

(7) The case 12 includes a third case body 23 having a plurality of third wire inserting portions 51 through which the electric wires 11 are inserted, and a plurality of third covers 26 attached to the third case body 23 to cover the plurality of third wire inserting portions 51. Further, the plurality of third covers 26 have shapes identical to each other. According to this configuration, parts control can be facilitated even with an increased total number of covers 12 due to the provision of the plurality of third covers 26 in addition to the first covers 24 and second covers 25.

The present embodiment may be implemented with modifications such as those below. The present embodiment and the modifications below may be implemented in combination as long as no technical contradiction arises.

The number of case bodies of the case 12 is not limited to the foregoing embodiment; rather, it may be changed as appropriate according to the size of the secondary battery BT in the longitudinal direction X, etc.

While the case 12 of the foregoing embodiment has a total of six covers, i.e., the first, second, and third covers 24 to 26, for covering the portions through which the electric wires 11 are inserted, the number of covers is not limited to the foregoing embodiment; rather, it may be changed according to the size of the secondary battery BT in the longitudinal direction X, etc.

Although the first covers 24 and the second covers 25 have shapes identical to each other in the foregoing embodiment, there is no limitation to this; it is sufficient that at least one of the first covers 24 and one of the second covers 25 have an identical shape.

Although the foregoing embodiment has a configuration in which the electric wires 11 are routed in the longitudinal direction X of the case 12, along which the battery cells C are provided side-by-side, other configurations may be possible; for example, a configuration is possible in which the electric wires 11 are routed in the width direction Y of the case 12.

### LIST OF REFERENCE NUMERALS

10 Battery wiring module
11 Electrical wire
12 Case
13 Busbar
14 First wire draw-out portion
15 Second wire draw-out portion
21 First case body
22 Second case body
23 Third case body
24 First cover
24a Surface
25 Second cover
25a Surface
26 Third cover
26a Surface
31 First wire inserting portion
32 First coupling portion
33 First bottom wall portion
34 First side wall portion
35 First engaged portion
41 Second wire inserting portion
42 Second coupling portion
43 Second bottom wall portion
44 Second side wall portion
45 Second engaged portion
51 Third wire inserting portion
52 Third coupling portion
53 Third bottom wall portion
54 Third side wall portion
55 Third engaged portion
61 First engaging portion
71 Second engaging portion
81 Third engaging portion
91 Mark
92 Mark
BT Secondary battery
C Battery cell
S Workbench
Sa Insertion portion
Sb Counterpart mark
Sc Counterpart mark
X Longitudinal direction of case 12
Y Width direction of case 12
Z Height direction of case 12

1. A battery wiring module for attachment to a secondary battery, comprising:
electric wires configured to be electrically connected to the secondary battery; and
a case configured to house the electric wires,
wherein the case includes
a first case body including a first wire inserting portion through which the electric wires are inserted,
a second case body including a second wire inserting portion through which the electric wires are inserted,
a first cover configured to be attached to the first case body and cover the first wire inserting portion, and
a second cover configured to be attached to the second case body and cover the second wire inserting portion, and
the first cover and the second cover have shapes identical to each other.

2. The battery wiring module according to claim 1,
wherein the first wire inserting portion includes a first bottom wall portion, a pair of first side wall portions extending from the first bottom wall portion, and a plurality of first engaged portions provided on the first side wall portions along a direction in which the electric wires are inserted,
the second wire inserting portion includes a second bottom wall portion, a pair of second side wall portions extending from the second bottom wall portion, and a plurality of second engaged portions provided on the second side wall portions along a direction in which the electric wires are inserted,
the first cover includes a plurality of first engaging portions configured to engage with the plurality of first engaged portions,
the second cover includes a plurality of second engaging portions configured to engage with the plurality of second engaged portions, and
arrangement intervals of the plurality of first engaged portions are set identical to arrangement intervals of the plurality of second engaged portions.

3. The battery wiring module according to claim 1,
wherein the first wire inserting portion includes a first bottom wall portion and a pair of first side wall portions extending from the first bottom wall portion,
the second wire inserting portion includes a second bottom wall portion and a pair of second side wall portions extending from the second bottom wall portion, and
a distance between the pair of first side wall portions is set identical to a distance between the pair of second side wall portions.

4. The battery wiring module according to claim 1,
wherein the first case body includes a plurality of the first wire inserting portions,
a plurality of the first covers are provided in correspondence with the plurality of first wire inserting portions,
the second case body includes a plurality of the second wire inserting portions,
a plurality of the second covers are provided in correspondence with the plurality of second wire inserting portions, and
the first covers and the second covers all have an identical shape.

5. The battery wiring module according to claim 1, wherein the first cover and the second cover each have a mark thereon that indicates an orientation of attachment to a corresponding first case body or second case body.

6. The battery wiring module according to claim 5, wherein the marks are provided on a surface of the first cover and a surface of the second cover.

7. The battery wiring module according to claim 1,
wherein the case includes a third case body having a plurality of third wire inserting portions through which the electric wires are inserted, and a plurality of third covers configured to be attached to the third case body and cover the plurality of third wire inserting portions, and
the plurality of third covers have shapes identical to each other.
